(19) United States
(12) Patent Application Publication
(10) Pub. No.: US 2026/0202894 A1
(43) Pub. Date: Jul. 16, 2026

(54) USB CONNECTION UNIT

(71) Applicant: Bury Sp.z.o.o., Mielec (PL)

(72) Inventors: Marco C. MILAZZO, Herford (DE); Krzysztof SOLTYSIK, Rzeszow (DE); Miroslaw ROBAK, Mielec (PL)

(73) Assignee: Bury Sp.z.o.o., Mielec (PL)

(21) Appl. No.: 19/419,699

(22) Filed: Dec. 15, 2025

(30) Foreign Application Priority Data
Dec. 16, 2024 (DE) 10 2024 138 082.9

(51) Int. Cl. G06F 1/26; G06F 1/28; G06F 13/38

(52) U.S. Cl. CPC G06F 1/266; G06F 1/28; G06F 13/385; G06F 2213/0042

(57) ABSTRACT

A USB connection unit with a control device and at least two USB ports connected to the control device is described. The control device is designed to detect a power supply request from a USB plug unit connected to a USB port. The control device is configured to measure the output current actually transmitted via the USB port to the USB plug unit requesting power and to reduce power limitations for the other USB ports of the USB connection unit when the measured output current is less than a predetermined first threshold value.

The invention relates to a USB connection unit with a control device and at least two USB ports connected to the control device, wherein the control device is designed to recognize a power supply request from a USB plug unit connected to a USB port.

The invention also relates to a method for detecting whether a USB device is connected to a USB port, even if a USB plug unit, such as a USB adapter cable, is plugged into a USB port and there is no power supply requirement or no device connected that can consume power.

Conventional USB connection units, also known as USB output modules, have several USB ports, whereby the module detects whether a port is connected to a USB plug unit, such as an adapter cable or a USB device.

The USB interface is a manufacturer-independent interface standard that allows various peripheral devices of a computer system to be connected to a main device, such as a computer, via a standardized plug connection. Before the introduction of this universal interface, computers had a variety of different interfaces, such as serial interfaces, parallel interfaces, keyboard and mouse interfaces, network interfaces, and monitor interfaces. These interfaces were each designed for a specific type of data communication, but with the exception of the keyboard and mouse interfaces, they did not provide power to the external device. This meant that the external devices had to be supplied with additional power, e.g., via a plug-in power supply. This was particularly true for external storage media, scanners, label printers, etc.

With the introduction of the USB interface, many of the aforementioned physical interfaces became obsolete, as either the devices to be connected also had the new USB interface, or there were adapters that converted the USB protocol to the old interface standard. As a result, mobile computers in particular now only had a number of USB interfaces instead of the conventional interfaces, such as serial or parallel interfaces. Another advantage of the new USB interface standard was the availability of a power supply for the external device. The voltage was fixed at 5.0 V, and a maximum current of 0.5 A was enabled via a protocol sequence, providing a power output of 2.5 W per interface. This power was sufficient for many devices, meaning that no additional power supply had to be connected.

This USB interface established itself in particular in the micro-USB version as a general charging interface for mobile phones. However, the maximum available power of 2.5 W was no longer sufficient for this, whereupon charging currents of up to approx. 2.5 A were defined. With a constant charging voltage of 5.0 V, mobile phones could be fully charged in one to two hours.

With the transition to the new USB-C interface standard, the USB-C Power Delivery Standard (USB-PD) was developed for power supply, which can deliver a variable voltage of up to 20 V at a maximum current of 5 A, transferring 100 W of power. Further developments envisage output voltages of up to 48 V at 5 A in order to achieve power outputs of up to 240 W.

A USB connection module can have one or more USB-C ports. For example, a module with 4 USB ports could have a maximum available power of 960 W, which would quickly lead to overheating of the electronics in the module, as every power conversion is accompanied by losses. Even a circuit with a very good efficiency of, for example, 95% would cause losses of approx. 50 W, which would lead to enormous heat generation in the small installation space of a module.

Typically, the USB power supply for modules with multiple USB ports is designed so that the maximum power of the power supply is less than the sum of the maximum powers of the individual ports. This means that it is not possible to provide the maximum power at all ports simultaneously. The power is distributed among the ports, with the maximum possible power that can be provided by the power supply being divided among the individual outputs. This is also known as “power sharing.” For example, each output is allocated a minimum power, and if a connected device has a higher power requirement, this is allocated to it within the limits of the available power. If several connected devices have higher power requirements that exceed the total power available from the power supply, the total available power must be divided up using various strategies and algorithms.

These strategies do not necessarily have to provide all devices with higher power requirements with an equal share of the available power; instead, certain devices can be prioritized. For example, if a connected scanner does not work at all with less power than required, it must be granted the required power in any case, while a mobile phone that needs power to charge its battery will simply take a little longer to charge with less power than desired.

To inform a USB module of the desired voltage and current, a device communicates with the USB module according to the USB PD (Power Delivery) standard. The device informs the module of one or more desired voltage-current configurations, and the module communicates the possible voltage-current configurations to the device. They then agree on a configuration that is possible for both sides. This requires that both the USB module and the connected device are set up for communication according to the USB PD standard. For backward compatibility with devices that are not set up for USB PD communication, the USB module can detect at least one identification resistor on the CC or data lines. If a device is connected that does not communicate according to the USB PD standard, but an identification resistor has been detected, the USB module provides a default value of, for example, 5 V at 3 A (equal to 15 W) or, if a BC 1.2-compatible device is detected, 7.5 W. The identification resistor can be installed in both the connected device and an adapter cable. The unit that contains at least the identification resistor and can be connected to a USB port, i.e., for example, a device, an adapter cable, or a combination of a device and an adapter cable, is hereinafter referred to as a USB plug unit for the purposes of the invention.

According to the USB-C Power Delivery Standard, a minimum power of 7.5 W must be reserved for each port, even if the USB port is not in use, in order to ensure a minimum supply to a newly plugged-in device. If a minimum power output is provided to each output and the remaining power is distributed to devices with higher power requirements, it may happen that the devices with higher power requirements have to forego part of their desired power output, while the unused ports or the devices connected to the ports with minimum power output do not draw the power provided to them. This is particularly the case when a USB adapter cable is plugged into some ports but there is no device at the other end. This situation can occur frequently, as many users simply leave the cable plugged in and disconnect the device at the other end.

These adapter cables, e.g., an iPhone Type-C to Lightning adapter or Type-C to Micro-USB adapter, are not just connection cables from one connector standard to another, but contain additional components, such as resistors for identification on the CC line. As soon as the cable is plugged into the USB port, the electronics in the USB module recognize via one or more identification resistors that there is a power requirement at the port, regardless of whether a device is connected at the other end of the adapter cable. The USB module then provides power for this port corresponding to the identification resistor.

EP 3 382 502 B1 discloses a USB power supply unit that provides power to USB-C ports in accordance with the USB PD standard and limits the power at the USB-C ports when a maximum total power is exceeded, based on a table of power profiles. The power requirement is detected by a controller that detects the connection and disconnection of devices to a USB-C port.

The objective of the present invention is to provide an improved USB connection unit and an improved method for controlling charging with such a USB connection unit.

The task is solved by the USB connection unit with the features of claim 1 and the method with the features of claim 10. Advantageous embodiments are described in the dependent claims.

It is proposed that the control device be configured to measure the output current actually transmitted via the USB port to the USB plug unit requesting power and to reduce power limitations for the other USB ports of the USB connection unit when the measured output current is less than a predetermined first threshold value.

This allows a USB plug unit that is plugged into a USB port and has an identification resistor for transmitting a power supply request to the USB connection unit to be supplied with power according to its actual power requirements. If the USB plug unit plugged into the USB port does not require any power, the power previously reserved for the USB port due to the identification resistor for the USB connection unit can be distributed to the other USB plug units.

The USB connection unit is thus configured to additionally measure the output current actually transmitted to a connected USB plug unit that has an identification resistor. However, the result of this current measurement only needs to be taken into account if the power request, i.e., the power supply requirement, is not signaled via communication according to the USB PD standard, but via the connection of at least one identification resistor, e.g., on the CC or data line of the USB port.

The current transmitted from the USB module to the connected device can typically be measured as a voltage drop across a shunt resistor in the USB supply line. However, other measurement methods are also possible, in particular current measurement via a measurement of the magnetic field around the conductor. For this purpose, there are, for example, Hall sensors that use the Hall effect to determine the magnetic field, which is a measure of the current flowing through the conductor. Other methods of current measurement can also be used.

If, after detecting the power request via the at least one identification resistor, no current flow exceeding the first threshold value is measured, such as a current of at least 200 mA, this connection is considered unused and the already reserved power is distributed to the other connections.

The control device can be set up to detect a connected USB plug unit to a USB port if the measured output current is greater than a second threshold value.

The first threshold value is preferably less than as the second threshold value. This causes a hysteresis behavior.

At least one USB port can be set up to provide power according to the USB Power Delivery standard. This allows the power request to be detected by means of data communication with a USB PD-compatible device.

The control device may be configured to detect a power request from a USB plug unit that is not compatible with the USB Power Delivery standard by measuring a characteristic identification resistance of the USB plug unit.

The control device can be set up to measure the at least one characteristic identification resistance on the data lines or communication lines of the USB port.

The control device can be set up to detect a power request from a USB plug unit that is compatible with the USB Power Delivery standard by means of data communication with the USB plug unit.

At least one of the USB ports may be a connector according to the USB-C standard, which has communication line contacts (CC1, CC2), data line contacts (D+, D−), a power supply contact (VBUS), and a ground contact (GND).

The control device may have several control units, each of which is designed to control at least one assigned USB port.

The invention is explained in more detail below with reference to embodiments and the accompanying drawings. They show:

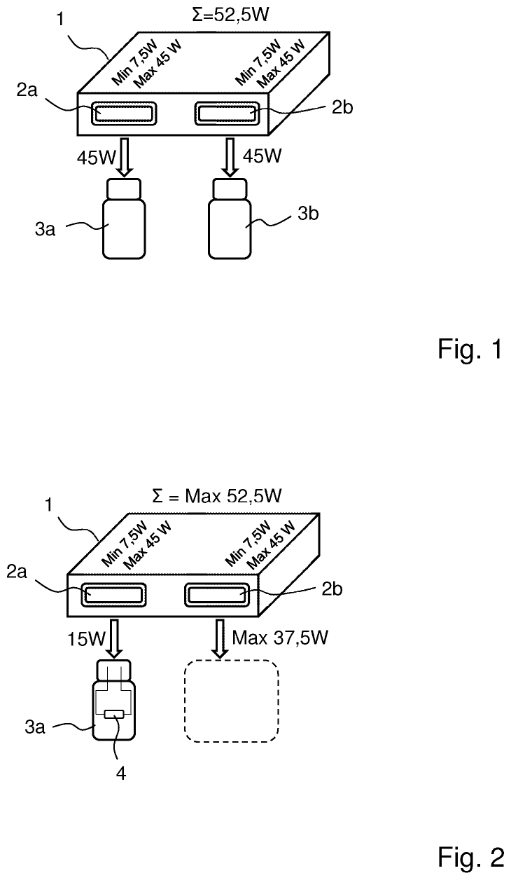

FIG. 1—Block diagram of a USB connection unit with two USB-C Power Delivery ports and two USB plug units connected thereto;

FIG. 2—Block diagram of the USB connection unit from FIG. 1 with an adapter cable connected to a USB port;

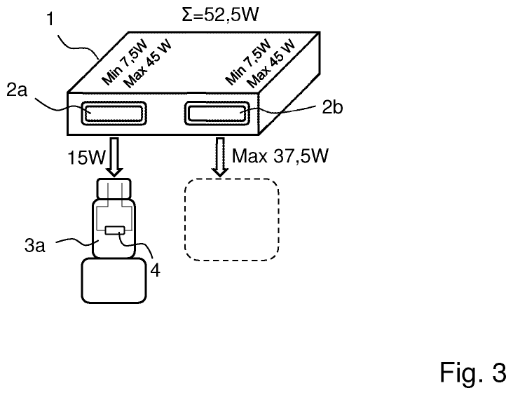

FIG. 3—Block diagram of the USB connection unit from FIG. 1 with a USB plug unit connected to a first USB port and power limitation on the second USB port;

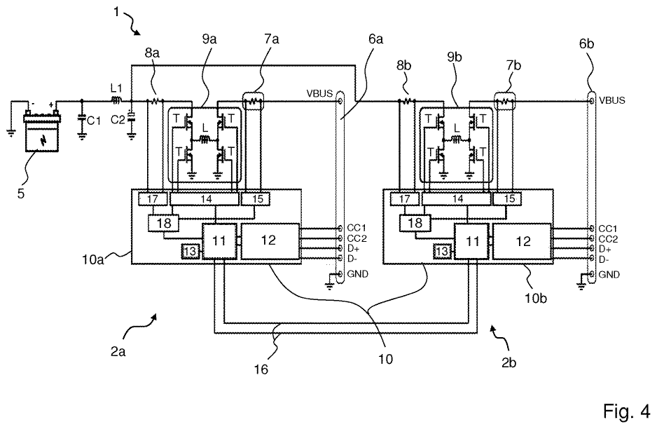

FIG. 4—Block diagram of a USB connection unit on a vehicle battery;

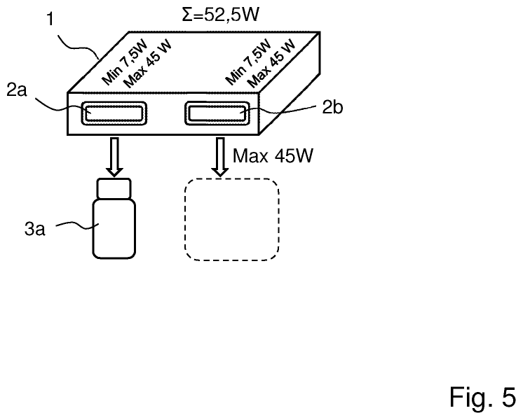

FIG. 5—Block diagram of the USB connection unit from FIG. 1 with a powerless adapter cable as a USB plug unit on a first USB port and no power reduction on the second USB port;

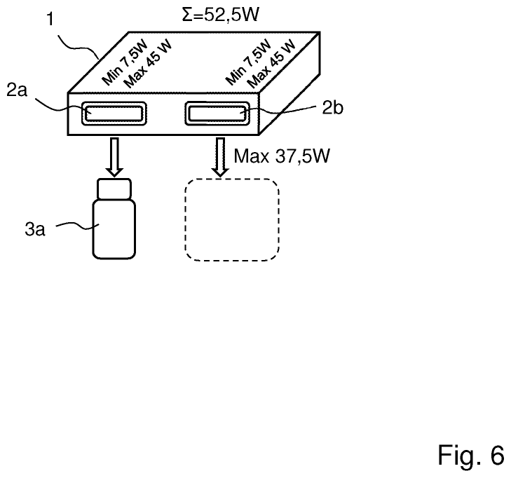

FIG. 6—Block diagram of the USB connection unit from FIG. 1 with a USB plug unit on a first USB port and power limitation on the second USB port.

FIG. 1 shows a block diagram of a USB connection unit 1 with two USB-C Power Delivery ports 2a, 2b and two USB plug units 3a, 3b connected to them.

The USB connection unit 1 (USB module) has two USB-C ports 2a, 2b according to the USB-C Power Delivery standard with a maximum power of 45 W per USB port 2a, 2b. The total power is limited to 52.5 W, which means that the power must be divided between the two ports. Each of the two USB ports 2a, 2b accepts power requests from a minimum of 7.5 W to a maximum of 45 W. Since a USB plug unit 3a, 3b that supports the USB PD standard is connected to both ports, the power is divided according to specific algorithms and priorities. For example, the left USB port 2a could have a power output of 15 W and the right USB port 2b could have a power output of 37.5 W.

FIG. 2 shows a block diagram of the USB connection unit 1 from FIG. 1 with an adapter cable as a USB plug unit 3a on a first USB port 2a.

An adapter cable is understood to be any USB connector with a connection option for a USB device, such as an adapter with connectors for the USB port and the USB device to be connected with an internal cable, or a USB cable with two connectors connected via an external cable.

It can be seen that an adapter cable (USB connection unit 3a) is plugged into the left USB port 2a, which signals a power requirement of 15 W via an identification resistor 4. No communication takes place here, as the adapter cable (USB plug unit 3a) is purely passive. The USB connection unit 1 now provides 15 W of power at the left USB port 2a, regardless of whether a device for power consumption is actually connected to the adapter cable (USB plug unit 3a) or not. The right USB port 2b is therefore limited to 37.5 W, even if the power requirement of the USB plug unit 3b connected to the right USB port 2b is greater.

This highlights the problem that when a plug unit 2a that has an identification resistor 4 but cannot draw power, such as an adapter cable, is connected, i.e., the assignment of USB port 2a without a device connected to it, power is still reserved for the plug unit 2a connected to the left USB port 2a, and thus the power distribution is not optimally balanced.

FIG. 3 shows a block diagram of the USB connection unit 1 from FIG. 1 with a USB plug unit 3a on a first USB port 2a and a power limitation on the second USB port 2b.

It can be seen that a device that does not communicate via the USB PD standard is connected to the left (first) USB port 2a via an adapter. A power of 15 W is available at the left USB port 2a, which the connected USB plug unit 3a, e.g., an earlier generation iPhone, uses to charge the battery. In this phase, the power distribution is well balanced again. The left USB plug unit 3a consumes 15 W of power and the right plug unit 3b has 37.5 W of power available. When the battery of the left USB plug unit 3a is almost fully charged, the power consumed by the left USB plug unit 3a is also reduced. However, the USB plug unit 3a still signals the power requirement of 15 W, which the USB connector 1 continues to provide. When the battery is fully charged and charging is complete, the left USB plug unit 3a no longer draws any power. However, the USB connector 1 continues to provide 15 W of power, and the right USB port 2b is still limited to a maximum power of 37.5 W. This means that the power distribution is again not optimal for fully utilizing the actually available total power of 52.5 W and making it available to the two USB ports 2a, 2b as needed.

FIG. 4 shows a block diagram of a USB connection unit 1 with two USB ports 2a, 2b on a vehicle battery 5. The USB ports 2a, 2b each have connection sockets 6a, 6b with contacts, which are each assigned to the signals CC1 and CC2 for communication according to the USB PD standard, to the data lines D+ and D− for data communication, to the power supply VBUS, and to ground GND.

A shunt resistor 7a, 7b (output current sense) is installed in the VBUS line that supplies power to the USB plug unit 3a, 3b in order to determine the current actually consumed by the USB plug unit 3a, 3b by measuring the voltage across this resistor. Another shunt resistor 8a, 8b is located in front of the input of each driver stage 9a, 9b in order to determine the driver input current by measuring the voltage across resistor 8a, 8b.

The desired voltage VBUS is generated with the help of the driver stages 9a, 9b shown, each of which consists of four MOSFET transistors T arranged in a full bridge circuit and a coil L in the middle of the full bridge. The MOSFET transistors T of the full bridge are controlled by a control unit 10a, 10b, such as a controller, which generates the four gate signals for the MOSFET transistors T. Furthermore, the control unit 10a, 10b receives a feedback signal from the generated output voltage VBUS in order to change the gate signals in a control loop so that exactly the desired voltage VBUS is always generated.

The two control units 10a, 10b together form a control device 10.

Both USB PD circuits 2a, 2b with driver stage 9a, 9b and input shunt resistor 8a, 8b are connected to a filter circuit consisting of at least one electrolytic capacitor C2 and/or a coil L1 and/or a further capacitor C1, all connected in a TT configuration. This serves to filter out interference caused by the switching of the MOSFET transistors T so that it is not transmitted via the supply line of the USB connection unit 1 and thus cannot interfere with other devices.

The control units 10a, 10b, which generate the gate signals, each contain a microprocessor core 11. Furthermore, a power delivery controller (PD controller) 12 is integrated in the periphery of each of the control units 10a, 10b each has a power delivery controller (PD controller) 12 integrated, which communicates with the connected USB plug unit 3a, 3b via the CC signals (CC1 and CC2) or via the data lines (D+ and D−). The PD controller 12 can also be implemented directly in the microprocessor core 11 as software. By communicating with the connected USB plug units 3a, 3b, the PD controller 12 negotiates the configuration via voltage and current and generates the gate signals so that they correspond to the configuration.

Furthermore, the control units 10a, 10b contain a non-volatile memory 13 which contains at least the possible current-voltage configurations of this USB port 2a, 2b.

The control units 10a, 10b, together with the driver stage 9a, 9b, are set up in such a way that they can generate both an output voltage VBUS that is greater than the input voltage (battery voltage) and an output voltage VBUS that is less than the battery voltage. This is commonly known as a buck-boost converter 14.

The control units 10a, 10b, together with the shunt resistors 7a, 7b, are set up so that they can limit the output current if the USB plug unit 3a, 3b connected to the respective USB port 2a, 2b draws a higher current than agreed in the configuration. For this purpose, the shunt resistor 7a, 7b is connected to a current measuring unit 15, which may have, for example, an analog-to-digital converter to convert the voltage drop across the shunt resistor into a digital value that can be evaluated by the controller. The current measuring unit 15 may be integrated into the controller.

The control units 10a, 10b can limit the output current if it exceeds the current specified by the configuration. The limitation can also only take effect if the absorbed current exceeds an additional tolerance value. The tolerance value may depend on other parameters, e.g., the input voltage, the output voltage, the temperature, or the duration of the exceedance.

The control units 10a, 10b may be set up to generate the gate signals as CC/CV control (constant current/constant voltage). As long as a current below the configured current limit is consumed, the driver stage 9a, 9b generates a constant voltage; if the load is increased by the connected device 3a, 3b and the current limit is exceeded, the voltage is reduced to a value so that only the configured current is delivered.

Furthermore, the PD controller 12 can detect whether pull-up or pull-down resistors are connected to the CC lines or data lines if no data communication is established. In this case, a configuration corresponding to the measured resistances is set and the corresponding power is reserved.

Both control units 10a, 10b are additionally connected to each other via further communication lines 16. They exchange information via these communication lines 16 and negotiate among themselves which control unit 10a, 10b may supply how much power to its connected USB plug unit 3a, 3b.

To measure the driver input current, the shunt resistors 8a, 8b are connected to a current measuring unit 17, which can be designed as an analog-to-digital converter, in order to measure the voltage drop across the respective shunt resistor 8a, 8b and convert it into a digital value proportional to the driver input current.

The current measuring unit 17 may be integrated into the controller.

The current measuring unit 17 may be connected to a protective circuit 18, which in turn may be connected to the current measuring unit 15, the microprocessor core 11, and the buck-boost converter 14.

FIG. 5 shows a block diagram of the USB connection unit 1 from FIG. 1 with a powerless adapter cable as a USB plug unit 3a on a first USB port 2a and unreduced power on the second USB port 2b.

This shows the case where a USB PD device, e.g., a notebook PC, is connected to the right (second) USB port 2b as a USB plug unit 3b and 45 W of power is transferred via this port. A USB-C to Lightning adapter cable 3a is then plugged into the left (first) USB port 2a. The control unit 10a detects a power request of 15 W via the identification resistors 4 and reserves this power for this first USB port 2a. As a result, the right USB port 2b is now limited to 37.5 W in order not to exceed the maximum available power of 52.5 W. After a short time, the left controller, i.e. the control unit 10a, detects that no power is actually being drawn and cancels the reservation. As a result, the right USB port 2b again provides the full 45 W. The right USB port 2b can even provide 52.5 W, as no power is now reserved for the left USB port 2a. The left (first) USB port 2a nevertheless remains active and continues to provide the 5 V supply voltage VBUS at the output.

After some time, the adapter cable (USB plug unit 3a) connected to the left (first) USB port 2a is connected to a mobile phone, as shown in FIG. 6.

FIG. 6 shows a block diagram of the USB connection unit 1 from FIG. 1 with a USB plug unit 3a connected to the first USB port 2a and a power limit on the second USB port 2b.

The USB plug unit 3a connected to the left (first) USB port 2a detects the voltage applied to the first USB port 2a and knows that it may draw 15 W of power. As soon as the left controller, i.e., the control unit 10a, detects that a current of more than 200 mA is flowing, the control unit 10a again reserves the 15 W of power in accordance with the power requirement of the connected first USB plug unit 3a, which results in the right (second) USB port 2b being limited to a power of 37.5 W again.

After some time, the USB plug unit 3a connected to the first USB port 2a, i.e., for example, a mobile phone, is fully charged and the charging current drops below 200 mA. The left controller, i.e., control unit 10a, measures an output current of less than 200 mA and cancels the reservation of the requested power of 15 W. The right (second) USB port 2b can now provide the USB plug unit 3b connected to this second USB port 2b with the full power of 45 W or even the total power of 52.5 W. The left (first) USB port 2a continues to generate the output voltage VBUS of 5 V, which means that a trickle charge current of less than 200 mA continues to flow. The maximum power consumption of 1 W is not included in the power sharing balance. The system is designed in such a way that the additional small amount of power is tolerated by the system.

The second threshold value for detecting a connected USB plug unit 3a, 3b has been set to 200 mA in this example. However, this first threshold value can also be any other reasonable value. The second threshold value can be configurable. To avoid frequent switching between power reservation and cancellation of the reservation, a hysteresis can be built in. For this purpose, the first threshold value for controlling the power reduction can be smaller than the second threshold value for detecting a connected USB plug unit 3a, 3b. The second threshold value for detecting a connected USB plug unit 3a, 3b can also be divided into two parts and have a lower threshold value for detecting a free USB port 2a, 2b without a connected USB plug unit 3a, 3b and an upper threshold value for detecting an occupied USB port 2a, 2b with a connected USB plug unit 3a, 3b. For example, a parameterization is conceivable in which the control unit 10 detects a connected USB plug unit 3a, 3b when the current rises above 300 mA and does not detect a connected USB plug unit 3a, 3b when the current falls below 200 mA.

As can be seen from the examples, this method of detecting a connected device has the advantage that in some cases, the second USB port 2b can draw full power of, for example, 45 W or total power of, for example, 52.5 W much more often instead of the reduced power of, for example, 30 W, which results in faster charging of the notebook battery. Furthermore, the habit of leaving a USB plug unit 3a, 3b in the form of an unused adapter cable plugged into the first USB port 2a, even when no device is connected, does not adversely affect the charging time of the notebook at the second USB port 2b.

The power distribution described with two USB ports 2a, 2b can be extended in the same way to more than two USB ports 2a, 2b. The relationships described above are therefore not limited to two USB ports 2a, 2b, but apply to any number of USB ports 2a, 2b, . . . , 2n of a USB port unit 1.

### LIST OF REFERENCE SYMBOLS

1 USB connection unit
2a, 2b USB port
3a, 3b USB plug unit
4 Identification resistor
5 Vehicle battery
6a, 6b Connection socket
7a, 7b Shunt resistor
8a, 8b Shunt resistor
9a, 9b Driver stage
10 Control device
10a, 10b Control unit
11 Microprocessor core
12 Power delivery controller (PD controller)
13 Memory
14 Buck-boost converter
15 Current measurement unit
16 Communication line
17 Current measurement unit
18 Protection circuit
C1 Capacitor
C2 Electrolytic capacitor
CC1, CC2 Communication signals
D+, D− Data line
GND Ground
L1 Coil
L Coil
T MOSFET transistor
VBUS Power supply

1. USB connection unit with a control device and with at least two USB ports connected to the control device, wherein the control device is set up to detect a power supply request from a USB plug unit connected to a USB port, characterized in that the control device is designed to measure the output current actually transmitted via the USB port to the USB plug unit requesting power and for reducing power limitations for the other USB ports of the USB connection unit when the measured output current is less than a predetermined first threshold value.

2. USB connection unit according to claim 1, characterized in that the control device is designed to detect the connection of a connected USB plug unit to a USB port when the measured output current is greater than a second threshold value.

3. USB connection unit according to claim 2, characterized in that the first threshold value is less than the second threshold value.

4. USB connection unit according to claim 1, characterized in that at least one USB port is configured to provide power according to the USB Power Delivery standard.

5. USB connection unit according to claim 1, characterized in that the control device is configured to detect a power request from a USB plug unit that is not compatible with the USB Power Delivery standard by measuring at least one characteristic identification resistance of the USB plug unit.

6. USB connection unit according to claim 5, characterized in that the control device is designed to measure the at least one characteristic identification resistance on the data lines or communication lines of the USB port.

7. USB connection unit according to claim 1, characterized in that the control device is designed to recognize a power request from a USB plug unit compatible with the USB Power Delivery standard by means of data communication with the USB plug unit.

8. USB connection unit according to claim 1, characterized in that at least one of the USB ports is a connector according to the USB-C standard comprising communication line contacts, data line contacts, a power supply contact, and a ground contact.

9. USB connection unit according to claim 1, characterized in that the control device has several control units, each of which is designed to control at least one assigned USB port.

10. Method for controlling charging of a USB connection unit according to claim 1, characterized by measuring the output current actually transmitted via the USB port to the USB plug unit, which requests power, and reducing power limits for the other USB ports of the USB port unit if the measured output current is less than a predetermined first threshold value.

11. Method according to claim 10, characterized by detecting a USB plug unit connected to a USB port when the measured output current is greater than a second threshold value, wherein the first threshold value is less than the second threshold value.

12. Method according to claim 10, characterized by recognizing a power request from a USB plug unit by measuring at least one characteristic identification resistor of the USB plug unit and recognizing a power request from a USB plug unit that is compatible with the USB Power Delivery standard by communicating data with the USB plug unit.
